(19) United States
(12) Patent Application Publication
(10) Pub. No.: US 2020/0170273 A1
(43) Pub. Date: Jun. 4, 2020

(54) Olive Oil Jelly

(71) Applicant: Stephanie Ann Green, Milwaukie, OR (US)

(72) Inventor: Stephanie Ann Green, Milwaukie, OR (US)

(21) Appl. No.: 16/208,548

(22) Filed: Dec. 3, 2018

(51) Int. Cl. A23D 7/005; A23D 7/04

(52) U.S. Cl. CPC A23D 7/0053; A23D 7/04; A23V 2250/182; A23V 2200/228; A23V 2250/5086; A23V 2002/00

(57) ABSTRACT

The purpose of this patent application is to obtain a patent on Olive Oil Jelly. The main purpose for this invention is to benefit the food industry and average consumer, campers and Astronauts alike. Olive oil in the tradition bottle is messy and leaves oil residue or stains on surfaces that it touches or drips on. The current state of Olive Oil is via a bottle and when the bottle is touched it is usually laced with greasy oil that will stain counters, clothes or hands. When Olive Oil is poured into the pan, olive oil splashes onto the counter, burner and all over the bottle. Then typically when Olive Oil is done being used, the cook or chef places it back in the pantry further getting more olive oil on hands, clothes, counter and pantry. The Olive Oil Jelly will alleviate the mess, while gaining time efficiency in terms of having the Olive Oil already measured out and already properly spiced. Not to mention the cost savings with Olive Oil Jelly as now the main consumer does not need 10 bottles of spices per dish.

### CROSS-REFERENCE TO RELATED APPLICATIONS

Per 37 CFR 1.76, Stephanie Ann Green has not previously filed a provisional patent.

### STATEMENT REGARDING FEDERALLY SPONSORED RESEARCH OR DEVELOPMENT (IF APPLICABLE)

There are no rights to this invention under federally sponsored research and development programs.

### REFERENCE TO SEQUENCE LISTING, A TABLE, OR A COMPUTER PROGRAM LISTING COMPACT DISC APPENDIX

This section is non-applicable to this patent application.

### BACKGROUND OF THE INVENTION

This invention is a new invention in which no patents or ideas already exist. This is a brand new product that will be brought to the market. This invention does not improve any other product on the market. It s a new product and that is standalone. The main impetus for the Olive Oil Jelly is to save time and save from a messy clean up. Also the main purpose is so that all can start to enjoy cooking and get their food perfectly spiced with Olive Oil Jelly.

Stephanie Ann Green is an avid home chef and cook. Most of her days are spent in the kitchen cooking; while she is not at work or spending time with her three kids. Every time she cooks, she has to open a greasy bottle of olive oil and add it the pan, while dripping olive oil on the side of the pan, onto the burner, on the floor and counter. It is one of those things that as a chef, she dreads. That is when the Olive Oil Jelly was invented. Open a bottle of Olive Oil Jelly and squeeze or drop it in the pan to start cooking. The Jelly melts upon the activation of heat, releasing the olive oil and spices. Very simple invention and any spice can be added and any type of olive oil can be used. The options are endless. Some Olive Oil Jelly with be manufactured plain and others will have spices and any possible herb combination. The convenience of Olive Oil Jelly will benefit consumers, campers, Astronauts and everyone alike. The Jelly is a cleaner way to cook. Olive Oil Jelly is more cost effective than purchasing 10 bottles of spices (spices are very costly).

### BRIEF SUMMARY OF THE INVENTION FOLLOWED BY DETAILS

As mentioned above, there is a huge market and need for this product. The invention uses the following to make Olive Oil Jelly:
Xanthan Gum
olive oil
water
Mono & Diglyceride (any monoglyceride and diglyceride from fatty acids)
Spices if desired

The importance of making Olive Oil Jelly is the order in which ingredients are added. Olive Oil is first placed in the pan with fresh spices and no heat. Then the monoglyceride is added and whisked together. The oil is then brought to a slow boil and then water is added, and then the gum is added. Cook at low boil for a few minutes until mixture starts to change consistency and thicken. Remove from heat and cool Olive Oil Jelly has been created. Any type of olive oil can be used. Any and all herbs and oils are in scope of this product. The options are endless.

### BRIEF DESCRIPTION OF THE SEVERAL VIEWS OF THE DRAWING

FIG. 01 is a real prototype of what the actual products looks like. FIG. 01 has two components as identified below:

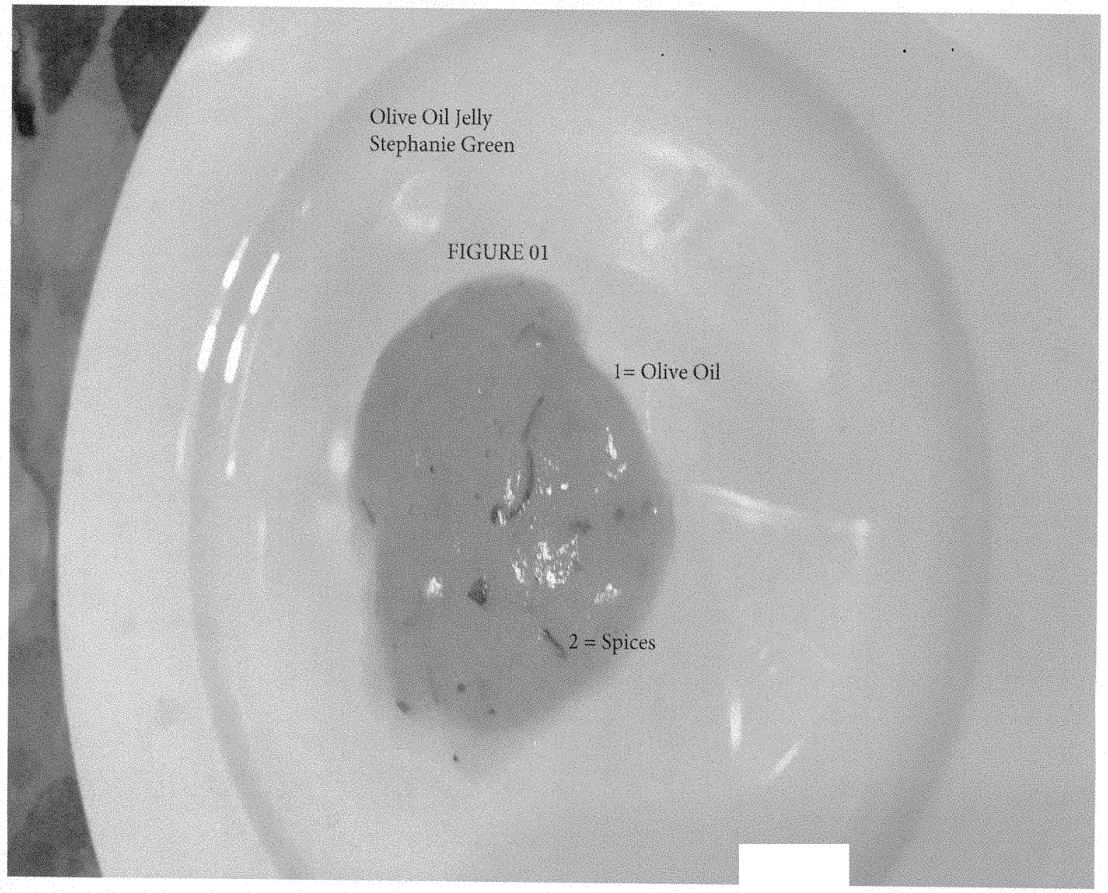

1=The Olive Oil that has been slightly solidified

2=The herbs and spices inside the Olive Oil Jelly (note Olive Oil Jelly can be made with or without spices as both are in scope of this invention)

1. Olive Oil that has been modified with ingredients to make the olive oil change from a liquid form to a solid form that resembles the substance of a jam and includes;
(a) a traditional olive oil that has been modified by adding ingredients to be a solid consistency and resembles that of a jam consistency
(b) ingredients such as any monoglyceride and diglyceride from fatty acids, Xanthan Gum and water added to the olive oil to change the liquid to a solid that resembles the consistency of jam
(c) olive oil that has been solidified that can be used in lieu of butter and spread onto toast like butter
(e) olive oil that has been solidified that can be used in lieu of traditional olive oil and added to a pan to cook with
(d) solidified olive oil that spices such as salt, pepper, garlic, basil and other savory herbs can be added to
